(19) United States
(12) Patent Application Publication
(10) Pub. No.: US 2013/0049449 A1
(43) Pub. Date: Feb. 28, 2013

(54) BRAKE CONTROL APPARATUS

(71) Applicant: Asahi WATANABE, Fujisawa-shi (JP)

(72) Inventor: Asahi WATANABE, Fujisawa-shi (JP)

(73) Assignee: HITACHI AUTOMOTIVE SYSTEMS, LTD.

(21) Appl. No.: 13/551,031

(22) Filed: Jul. 17, 2012

(30) Foreign Application Priority Data
Aug. 29, 2011 (JP) 2011-185625

(51) Int. Cl. B60T 13/58; B60T 13/74

(52) U.S. Cl. 303/3

(57) ABSTRACT

A brake control apparatus used for a vehicle having a regenerative braking system has a brake circuit connecting a master cylinder and a wheel cylinder; a pump; a gate-out valve; a reservoir capable of storing a brake fluid that flows out from the master cylinder; and a control unit. The control unit has a brake fluid storage controlling section that stores the brake fluid flowing out from the master cylinder in the reservoir; a pressure increase controlling section that controls the gate-out valve in a valve closing direction and supplies the brake fluid stored in the reservoir to the wheel cylinder by the pump then increases the wheel cylinder pressure; and a pressure decrease controlling section that, when the regenerative braking system operates, pours the brake fluid supplied to and pressurized in the wheel cylinder into the reservoir through the pump then decreases the wheel cylinder pressure.

### BACKGROUND OF THE INVENTION

The present invention relates to a brake control apparatus.

A related art brake control apparatus has been disclosed in, for example, Japanese Patent Provisional Publication No. 2009-029173 (hereinafter is referred to as “JP2009-029173”).

In the brake control apparatus in JP2009-029173, a braking apparatus has a hydraulic braking system and a regenerative braking system, and a difference between a demand braking force according to driver's braking demand and a hydraulic braking force is set as a target regenerative braking force, thereby suppressing deterioration in brake pedal feeling during execution of regenerative braking.

### SUMMARY OF THE INVENTION

In the brake control apparatus of JP2009-029173, however, since the difference between the demand braking force and the hydraulic braking force is set as the target regenerative braking force, the regenerative braking can not adequately be performed. Thus, there is a possibility that an efficient recovery of power will not be achieved during execution of the regenerative braking.

It is therefore an object of the present invention to provide a brake control apparatus which is capable of effectively performing the regenerative braking.

According to one aspect of the present invention, a brake control apparatus used for a vehicle having a regenerative braking system, comprises: a pump provided in a brake circuit and driven by an electric motor; a first brake circuit connecting a master cylinder that produces a brake fluid pressure by driver's brake operation and a wheel cylinder that is configured so that the brake fluid pressure acts on and a wheel cylinder pressure is increased and decreased; a second brake circuit connecting the first brake circuit and a discharge side of the pump; a gate-out valve provided at a master cylinder side with respect to a connecting point of the second brake circuit, on the first brake circuit; a third brake circuit connecting a point positioned at the master cylinder side with respect to the gate-out valve on the first brake circuit and a suction side of the pump; a reservoir provided at the suction side of the pump on the third brake circuit and capable of storing a brake fluid that flows out from the master cylinder; and a control unit having: a brake fluid storage controlling section that stores the brake fluid flowing out from the master cylinder by the driver's brake operation in the reservoir; a pressure increase controlling section that controls the gate-out valve in a valve closing direction and supplies the brake fluid stored in the reservoir to the wheel cylinder by the pump then increases the wheel cylinder pressure; and a pressure decrease controlling section that, when the regenerative braking system operates, pours the brake fluid supplied to and pressurized in the wheel cylinder into the reservoir through the pump then decreases the wheel cylinder pressure.

According to another aspect of the present invention, a brake control apparatus used for a vehicle having a regenerative braking system, comprises: a pump provided in a brake circuit and driven by an electric motor; a first brake circuit connecting a master cylinder that produces a brake fluid pressure by driver's brake operation and a wheel cylinder that is configured so that the brake fluid pressure acts on and a wheel cylinder pressure is increased and decreased; a second brake circuit connecting the first brake circuit and a discharge side of the pump; a gate-out valve provided at a master cylinder side with respect to a connecting point of the second brake circuit, on the first brake circuit; a third brake circuit connecting a point positioned at the master cylinder side with respect to the gate-out valve on the first brake circuit and a suction side of the pump; a reservoir provided at the suction side of the pump on the third brake circuit and capable of storing a brake fluid that flows out from the master cylinder; a pump-out valve arranged on the second brake circuit; a discharge oil passage provided parallel to the second brake circuit and having a one-way valve that allows only a flow of the brake fluid in a direction in which the brake fluid is discharged from the pump; and a control unit having: a pressure increase controlling section that supplies the brake fluid stored in the reservoir to the wheel cylinder by the pump; and a pressure decrease controlling section that, when the regenerative braking system operates, pours the brake fluid supplied to the wheel cylinder into the reservoir through the pump-out valve and the pump.

According to a further aspect of the invention, a method for controlling brake of a brake apparatus used for a vehicle having a regenerative braking system, the brake apparatus has: a reservoir storing a brake fluid that flows out from a master cylinder by driver's brake operation; and a pump capable of bidirectional rotation, the method comprises: pumping up the brake fluid stored in the reservoir by a rotation in a forward rotation direction of the pump and supplying the brake fluid to a wheel cylinder; and returning the brake fluid in the wheel cylinder to the reservoir by a rotation in a reverse rotation direction of the pump in response to increase of a regenerative braking force produced by the regenerative braking system.

The other objects and features of this invention will become understood from the following description with reference to the accompanying drawings.

### BRIEF DESCRIPTION OF THE DRAWINGS

FIG. 1 is a hydraulic circuit of a hydraulic braking system of an embodiment 1.

FIG. 2 is a control block diagram of a control unit of the embodiment 1.

FIG. 3 is a control block diagram of a motor drive controlling section of the embodiment 1.

FIG. 4 is a drawing showing hydraulic paths during execution of a normal pressure increase control of the embodiment 1.

FIG. 5 is a drawing showing hydraulic paths during execution of a normal pressure decrease control of the embodiment 1.

FIG. 6 is a drawing showing hydraulic paths during execution of a regenerative brake cooperative pressure increase control of the embodiment 1.

FIG. 7 is a drawing showing hydraulic paths during execution of a regenerative brake cooperative pressure decrease control of the embodiment 1.

FIG. 8 is a drawing showing hydraulic paths during execution of a pedal stroke generation control of the embodiment 1.

FIG. 9 is a drawing showing operation modes of the embodiment 1.

FIG. 10 is a time chart showing an example of the operation.

FIG. 11 is a sectional view of a pump of the embodiment 1.

FIG. 12 is a drawing showing hydraulic paths during execution of a pedal stroke generation control of an embodiment 2.

FIG. 13 is a hydraulic circuit of a hydraulic braking system of an embodiment 3.

FIG. 14 is a hydraulic circuit of a hydraulic braking system of an embodiment 4.

FIG. 15 is a drawing showing hydraulic paths during execution of a regenerative brake cooperative pressure decrease control of the embodiment 4.

### DETAILED DESCRIPTION OF THE INVENTION

According to the present invention, it is possible to effectively perform the regenerative braking.

Embodiments of a brake control apparatus of the present invention will now be explained below with reference to the drawings.

### Embodiment 1

A hydraulic braking system of an embodiment 1 will be explained. The hydraulic braking system of the embodiment 1 is used for a vehicle, such as a hybrid vehicle and an electric vehicle, which is provided with a regenerative braking system.

### [Configuration of Hydraulic Circuit]

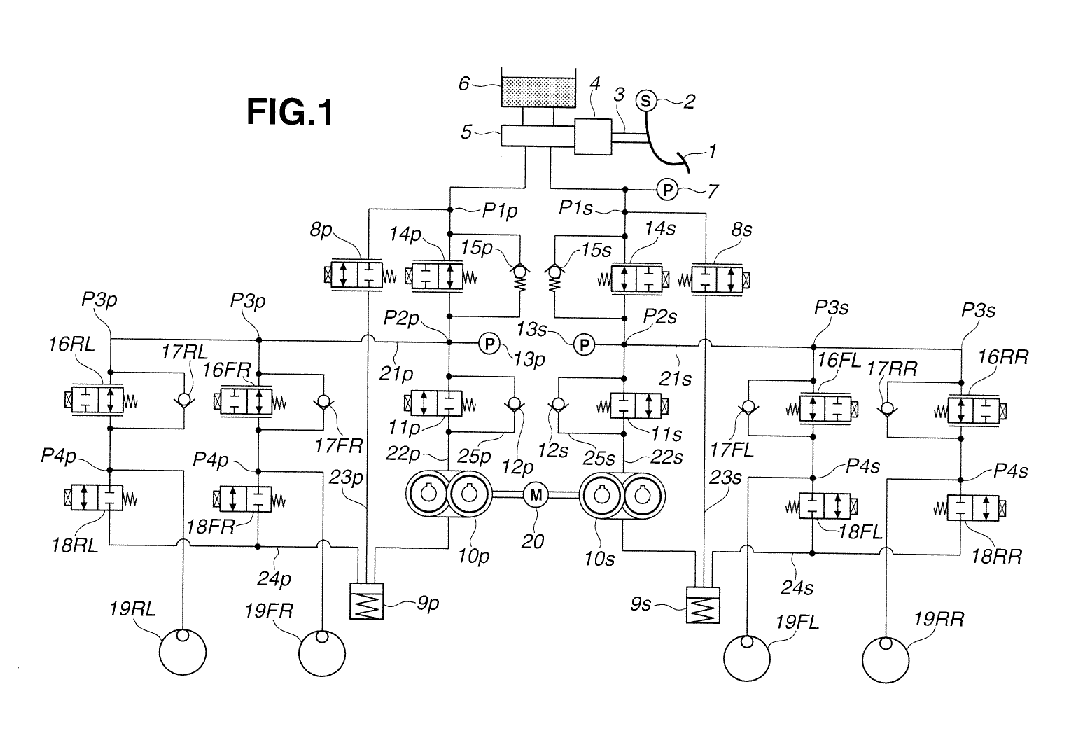

FIG. 1 is a hydraulic circuit of the hydraulic braking system. A brake pedal 1 is operated by a depression force of a driver. The brake pedal 1 is provided with a brake pedal stroke sensor (a brake operation state detecting section) 2 that detects a brake pedal stroke amount. An electric booster unit 4 is provided at a top end of a brake rod 3 attached to the brake pedal 1. The electric booster unit 4 provides thrust or propulsion to the brake rod 3 by an electric motor, and assists the driver with the depression of the brake pedal upon his/her braking operation.

A master cylinder 5 supplies brake fluid stored in a reservoir tank 6 to the hydraulic circuit in accordance with the stroke amount of the brake pedal 1.

The hydraulic circuit is formed by a primary hydraulic circuit that supplies the brake fluid to wheel cylinders 19FR, 19RL of a front right wheel FR and a rear left wheel RL and a secondary hydraulic circuit that supplies the brake fluid to wheel cylinders 19FL, 19RR of a front left wheel FL and a rear right wheel RR.

In the drawing, elements or components belonging to the primary hydraulic circuit are denoted with “p” added to the respective reference signs, while elements or components belonging to the secondary hydraulic circuit are denoted with “s” added to the respective reference signs. In the following description, since both configurations of the primary and secondary hydraulic circuits are almost the same, the elements or components of the primary and secondary hydraulic circuits, which do not specially require the respective explanations, will be explained without distinction.

The hydraulic braking system has a pump 10 driven by an electric motor 20, and thus can produce a hydraulic pressure by the pump 10 apart from production of the hydraulic pressure by the driver's brake pedal operation. This pump 10 is a gear pump that is capable of bidirectional rotation. The pump 10 also can recover the brake fluid from the wheel cylinders 19 by a reverse rotation of the pump 10 which is opposite to a rotation when producing the hydraulic pressure.

As shown in FIG. 1, the hydraulic braking system has a first brake circuit 21 that is connected from the master cylinder 5 to the wheel cylinder 19 through P1, P2, P3 and P4, a second brake circuit 22 that is connected from a discharge side, when producing the hydraulic pressure, of the pump 10 to P2, a third brake circuit 23 that is connected from P1 to a suction side, when producing the hydraulic pressure, of the pump 10, and a fourth brake circuit 24 that is connected from P4 to an after-mentioned reservoir 9.

On the first brake circuit 21, a gate-out valve 14 is provided at a master cylinder 5 side with respect to a connecting point (P2) connecting the first brake circuit 21 and the second brake circuit 22. This gate-out valve 14 is a normally-open type proportional valve. A relief valve 15 is provided parallel to the gate-out valve 14. This relief valve 15 is set to be opened when a pressure, at the master cylinder 5 side, of the gate-out valve 14 becomes equal to or higher than a predetermined pressure with respect to a pressure, at a wheel cylinder 19 side, of the gate-out valve 14. This is because the pressure, at the master cylinder 5 side, of the gate-out valve 14 is prevented from decreasing to or below a predetermined pressure with respect to the pressure, at the wheel cylinder 19 side, of the gate-out valve 14 during execution of a regenerative brake cooperative control. That is, a valve open pressure difference of the relief valve 15 is set to a pressure equivalent to a hydraulic pressure recovered during execution of the regenerative brake cooperative control.

Further, on the first brake circuit 21, a pressure increase valve 16 is provided between a branch point (P3) branching off to each wheel cylinder 19 and a connecting point (P4) connecting the first brake circuit 21 and the fourth brake circuit 24. This pressure increase valve 16 is a normally-open type proportional valve.

In addition, on a first brake circuit 21s of the secondary hydraulic circuit, a master cylinder pressure sensor 7 that detects a master cylinder pressure is provided at a master cylinder 5 side with respect to a connecting point (P1s) connecting the master cylinder 5 and a third brake circuit 23s.

On the first brake circuit 21, a discharge pressure sensor 13 that detects a discharge pressure of the pump 10 is also provided at the connecting point (P2) connecting the first brake circuit 21 and the second brake circuit 22.

On the second brake circuit 22, a pump-out valve 11 is provided. This pump-out valve 11 is a normally-closed type ON/OFF valve. A discharge oil passage 25 is provided parallel to the second brake circuit 22 so as to bypass the pump-out valve 11. On the discharge oil passage 25, a one-way valve 12 is provided. This one-way valve 12 allows a flow of the brake fluid in a direction in which the pump 10 discharges the brake fluid toward the wheel cylinder 19 side, and forbids a brake fluid flow of the opposite direction.

On the third brake circuit 23, the reservoir 9 is provided. Further, a gate-in valve 8 is provided between the master cylinder 5 and the reservoir 9 on the third brake circuit 23. This gate-in valve 8 is a normally-closed type proportional valve.

On the fourth brake circuit 24, a pressure decrease valve 18 is provided. This pressure decrease valve 18 is a normally-closed type ON/OFF valve.

### [Configuration of Control Unit]

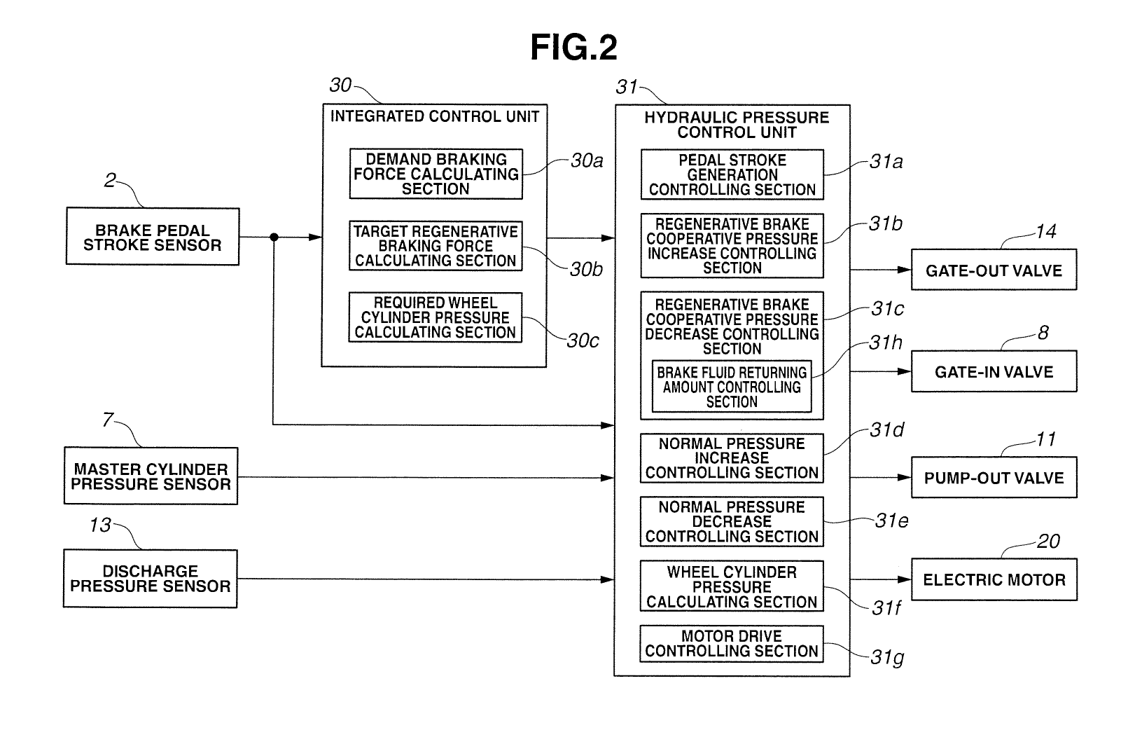

FIG. 2 is a control block diagram of an integrated control unit 30 and a hydraulic pressure control unit 31.

The integrated control unit 30 has a demand braking force calculating section 30a, a target regenerative braking force calculating section 30b and a required wheel cylinder pressure calculating section 30c.

The demand braking force calculating section 30a calculates a demand braking force of the driver on the basis of the brake pedal stroke amount inputted from the brake pedal stroke sensor 2.

The target regenerative braking force calculating section 30b calculates a target regenerative braking force produced by the regenerative braking. Regarding the target regenerative braking force, it is calculated as a braking force that can be efficiently regenerated, on the basis of e.g. a charge amount of a battery.

The required wheel cylinder pressure calculating section 30c calculates a braking force produced by the hydraulic braking system from a difference between the demand braking force of the driver and the target regenerative braking force, and calculates a wheel cylinder pressure required when the calculated braking force is produced.

The hydraulic pressure control unit 31 has a pedal stroke generation controlling section (a brake fluid storage controlling section) 31a, a regenerative brake cooperative pressure increase controlling section 31b, a regenerative brake cooperative pressure decrease controlling section 31c, a normal pressure increase controlling section 31d, a normal pressure decrease controlling section 31e, a wheel cylinder pressure calculating section 31f and a motor drive controlling section 31g.

The pedal stroke generation controlling section 31a performs a control so as to secure the brake pedal stroke amount during execution of the regenerative braking. More specifically, the pedal stroke generation controlling section 31a closes the gate-out valve 14 and opens the gate-in valve 8. With this control, the brake fluid flowing out from the master cylinder 5 by the driver's brake operation is stored in the reservoir 9.

The regenerative brake cooperative pressure increase controlling section 31b performs a control so as to increase the wheel cylinder pressure when the braking force by the regenerative braking is less than the demand braking force (i.e. when the demand braking force can not be covered by the regenerative braking force). More specifically, the regenerative brake cooperative pressure increase controlling section 31b closes the gate-out valve 14 and supplies the brake fluid stored in the reservoir 9 to the wheel cylinder 19 by the pump 10, then increases the wheel cylinder pressure.

The regenerative brake cooperative pressure decrease controlling section 31c performs a control so as to decrease the wheel cylinder pressure when the braking force by the regenerative braking satisfies the demand braking force (i.e. when the demand braking force can be covered by the regenerative braking force). More specifically, the regenerative brake cooperative pressure decrease controlling section 31c closes the gate-out valve 14, opens the pump-out valve 11 and sends the brake fluid in the wheel cylinder 19 to the reservoir 9 by the pump 10, then decreases the wheel cylinder pressure.

Here, the regenerative brake cooperative pressure decrease controlling section 31c has a brake fluid returning amount controlling section 31h.

The brake fluid returning amount controlling section 31h controls an amount of the brake fluid that returns from the wheel cylinder 19 to the reservoir 9. When the pump-out valve 11 is opened, the wheel cylinder pressure acts on the pump 10, and then attempts to drive the pump 10 in the reverse rotation direction. The brake fluid returning amount controlling section 31h controls the brake fluid returning amount by giving a rotation drag (or rotation resistance) in a forward rotation direction to the pump 10 by the electric motor 20. In other words, the brake fluid returning amount controlling section 31h controls the brake fluid returning amount by controlling a rotation speed, in a reverse rotation direction, of the electric motor 20.

The normal pressure increase controlling section 31d performs a control so as to increase the wheel cylinder pressure by or in response to the driver's brake operation. More specifically, the normal pressure increase controlling section 31d opens the gate-out valve 14 and supplies the brake fluid flowing out from the master cylinder 5 to the wheel cylinder 19, then increases the wheel cylinder pressure.

The normal pressure decrease controlling section 31e performs a control so as to decrease the wheel cylinder pressure by or in response to the driver's brake operation. More specifically, the normal pressure decrease controlling section 31e opens the gate-out valve 14 and returns the brake fluid of the wheel cylinder 19 to the reservoir tank 6, then decreases the wheel cylinder pressure.

The wheel cylinder pressure calculating section 31f calculates the hydraulic pressure of each wheel cylinder 19 from the discharge pressure of the pump 10 by the discharge pressure sensor 13 and a control amount of the pressure increase valve 16.

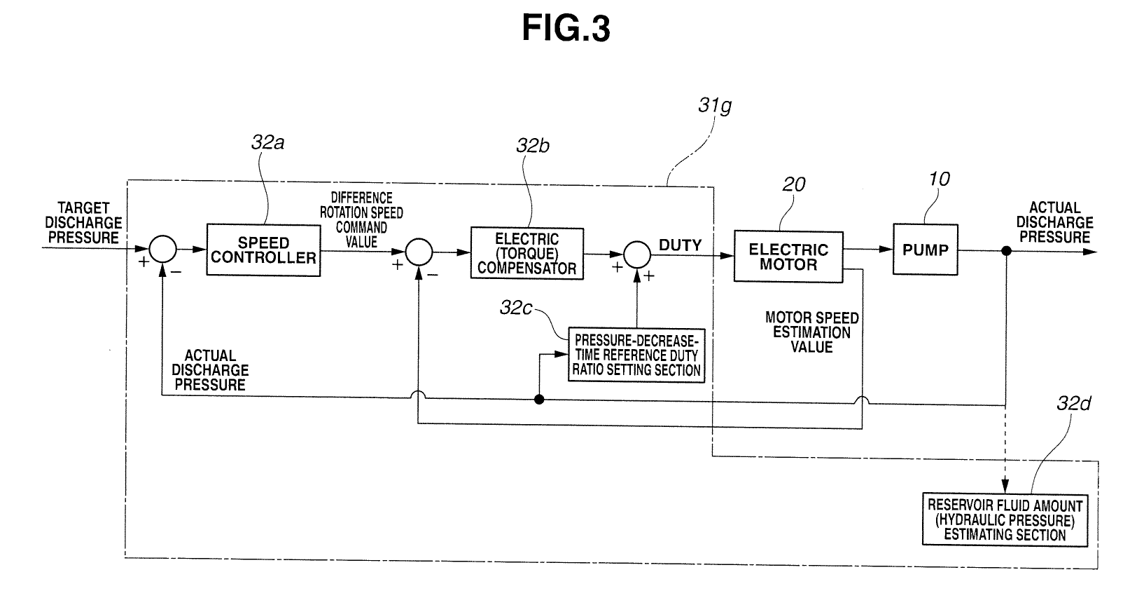

The motor drive controlling section 31g controls a current duty ratio that is sent to the electric motor 20. FIG. 3 is a control block diagram of the motor drive controlling section 31g. The motor drive controlling section 31g has a speed controller 32a, a current compensator 32b, a pressure-decrease-time reference duty ratio setting section 32c and a reservoir fluid amount estimating section 32d.

The speed controller 32a inputs a difference between a target discharge pressure and an actual discharge pressure, and calculates a difference rotation speed command value. The target discharge pressure is set in accordance with the required wheel cylinder pressure. The difference rotation speed command value is set to a rotation speed of the electric motor 20 which can produce a braking pressure equivalent to a shortfall of the target discharge pressure.

The current compensator 32b inputs a difference between the difference rotation speed command value and a motor speed estimation value, and calculates a command current duty ratio.

The pressure-decrease-time reference duty ratio setting section 32c converts an amount of the brake fluid that leaks by the pump 10 to the current duty ratio from the actual discharge pressure. The command current duty ratio of the electric motor 20 is set with this converted duty ratio added to the command current duty ratio.

The reservoir fluid amount estimating section 32d monitors or checks a change of the discharge pressure, and estimates the brake fluid amount stored in the reservoir 9. When the brake fluid amount in the reservoir 9 is large, there is a risk that pressure decrease can not be performed upon execution of ABS control. Further, when the brake fluid amount in the reservoir 9 is large and the pressure becomes high, there is a risk that sealing performance of the pump 10 can not be ensured. Thus, when the brake fluid amount in the reservoir 9 increases and the pressure in the reservoir 9 becomes higher than the discharge pressure detected by the discharge pressure sensor 13, the reverse rotation of the electric motor 20 is forbidden.

With regard to ensuring this sealing performance of the pump 10, it will be explained in detail later.

[Operation of Hydraulic Braking System]

Next, operation of the hydraulic braking system will be explained. In the hydraulic braking system of the embodiment 1, since the brake control is executed together with the regenerative braking system, the control is different according to not only a change of the driver's braking demand but also a change of the regenerative braking. In the following description, (a) normal pressure increase control, (b) normal pressure decrease control, (c) regenerative brake cooperative pressure increase control, (d) regenerative brake cooperative pressure decrease control, and (e) pedal stroke generation control will be explained.

(a) Normal Pressure Increase Control

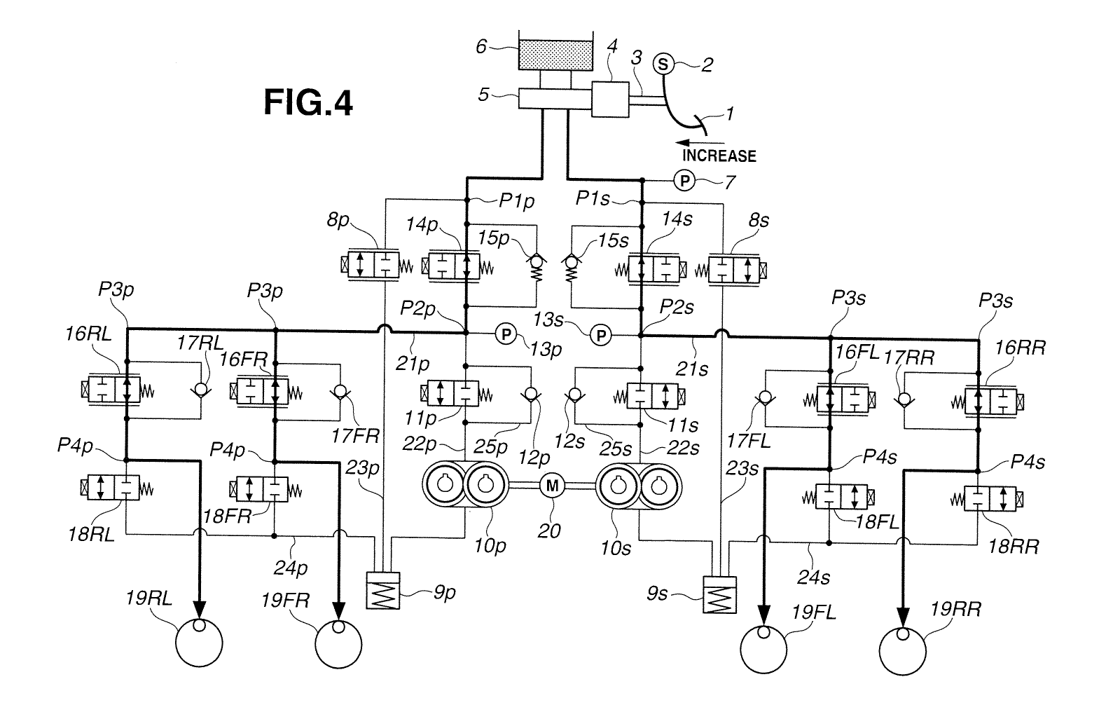

FIG. 4 is a drawing showing hydraulic paths during execution of the normal pressure increase control. The normal pressure increase control is a control that, when the brake pedal stroke amount is increased by the driver's brake operation, directly supplies the brake fluid from the master cylinder 5 to the wheel cylinder 19. The gate-in valve 8, the gate-out valve 14, the pressure increase valve 16, the pressure decrease valve 18, the pump-out valve 11 and the pump 10 at this time are controlled as follows.
gate-in valve 8: closed
gate-out valve 14: open
pressure increase valve 16: open
pressure decrease valve 18: closed
pump-out valve 11: closed
pump 10: stop

The brake fluid is supplied in the following order: the reservoir tank 6→the master cylinder 5→the gate-out valve 14→the pressure increase valve 16→the wheel cylinder 19.

(b) Normal Pressure Decrease Control

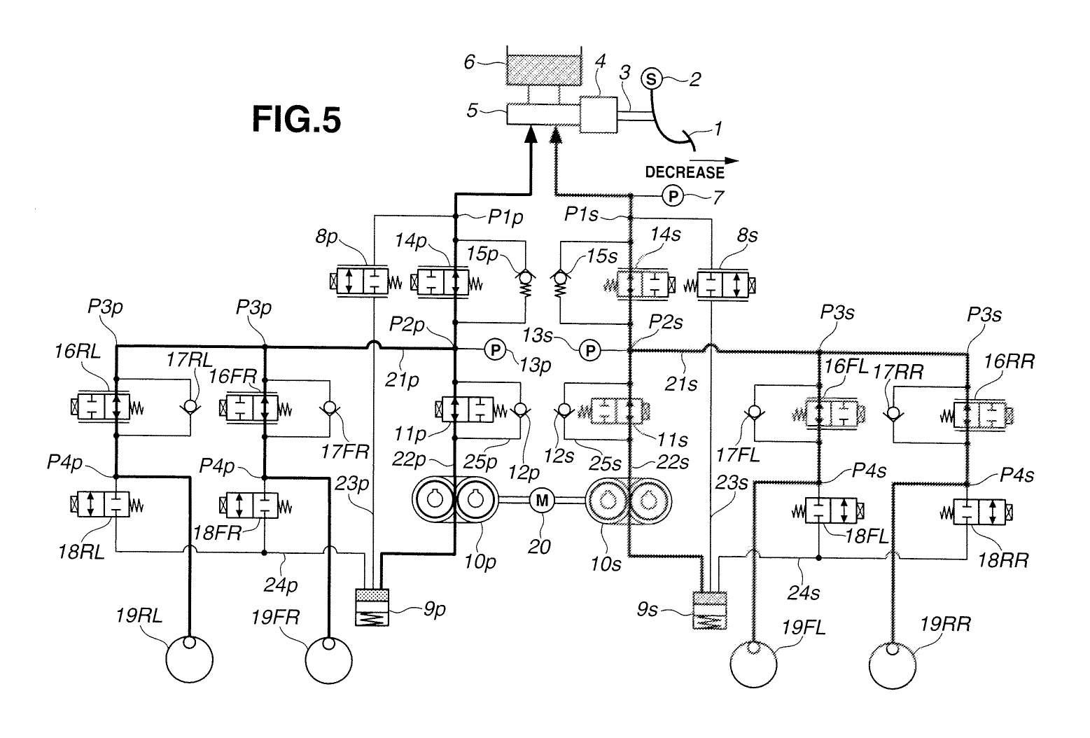

FIG. 5 is a drawing showing hydraulic paths during execution of the normal pressure decrease control. The normal pressure decrease control is a control that, when the brake pedal stroke amount is decreased by the driver's brake operation, recovers the brake fluid from the wheel cylinder 19 into the reservoir tank 6. In addition, when the brake fluid is stored in the reservoir 9, the brake fluid is recovered from the reservoir 9 into the reservoir tank 6. The gate-in valve 8, the gate-out valve 14, the pressure increase valve 16, the pressure decrease valve 18, the pump-out valve 11 and the pump 10 at this time are controlled as follows.
gate-in valve 8: closed
gate-out valve 14: open
pressure increase valve 16: open
pressure decrease valve 18: closed
pump-out valve 11: open
pump 10: forward rotation

The brake fluid is recovered in the following order: the wheel cylinder 19→the pressure increase valve 16→the gate-out valve 14→the master cylinder 5→the reservoir tank 6. In addition, when the brake fluid is stored in the reservoir 9, the electric motor 20 is energized so that the pump 10 rotates in the forward rotation direction, and the brake fluid is recovered in the following order: the reservoir 9→the pump 10→the pump-out valve 11→the gate-out valve 14→the master cylinder 5→the reservoir tank 6.

(c) Regenerative Brake Cooperative Pressure Increase Control

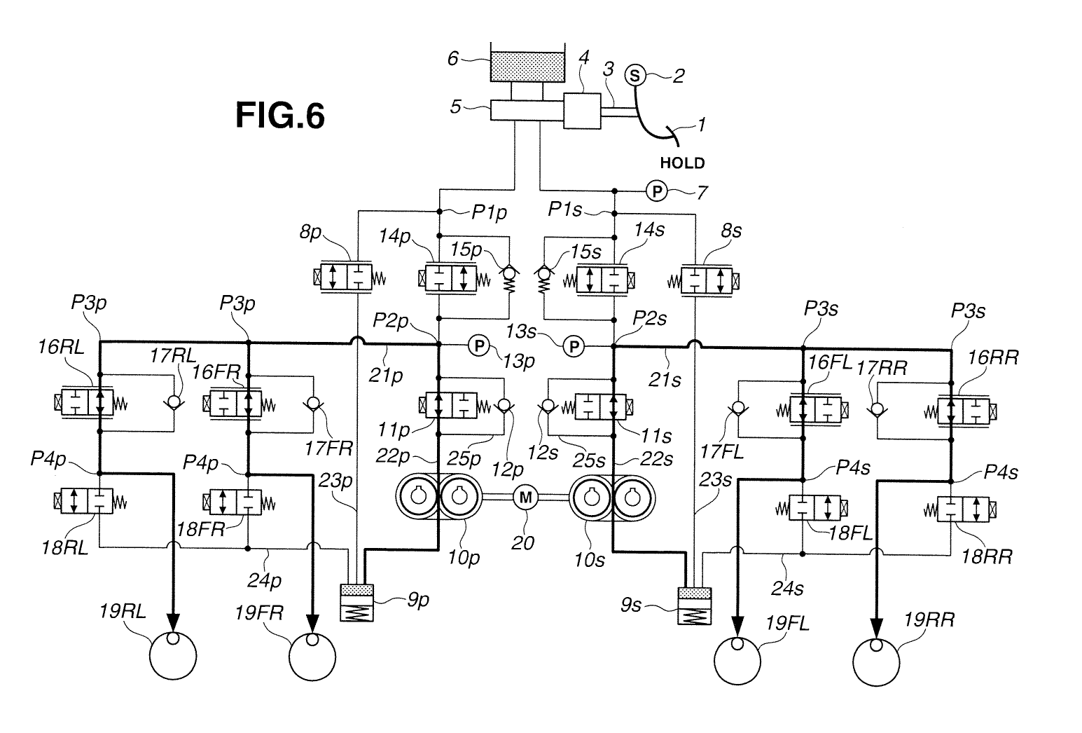

FIG. 6 is a drawing showing hydraulic paths during execution of the regenerative brake cooperative pressure increase control. The regenerative brake cooperative pressure increase control is a control that supplies the brake fluid generating the hydraulic pressure (the hydraulic braking force) which is equivalent to a shortfall of the braking force in the regenerative braking during execution of the regenerative braking, from the reservoir 9 to the wheel cylinder 19 by the pump 10. The gate-in valve 8, the gate-out valve 14, the pressure increase valve 16, the pressure decrease valve 18, the pump-out valve 11 and the pump 10 at this time are controlled as follows.
gate-in valve 8: closed
gate-out valve 14: closed
pressure increase valve 16: open
pressure decrease valve 18: closed
pump-out valve 11: open
pump 10: forward rotation

The brake fluid is supplied in the following order: the reservoir 9→the pump 10→the pump-out valve 11 (or the one-way valve 12)→the pressure increase valve 16→the wheel cylinder 19.

(d) Regenerative Brake Cooperative Pressure Decrease Control

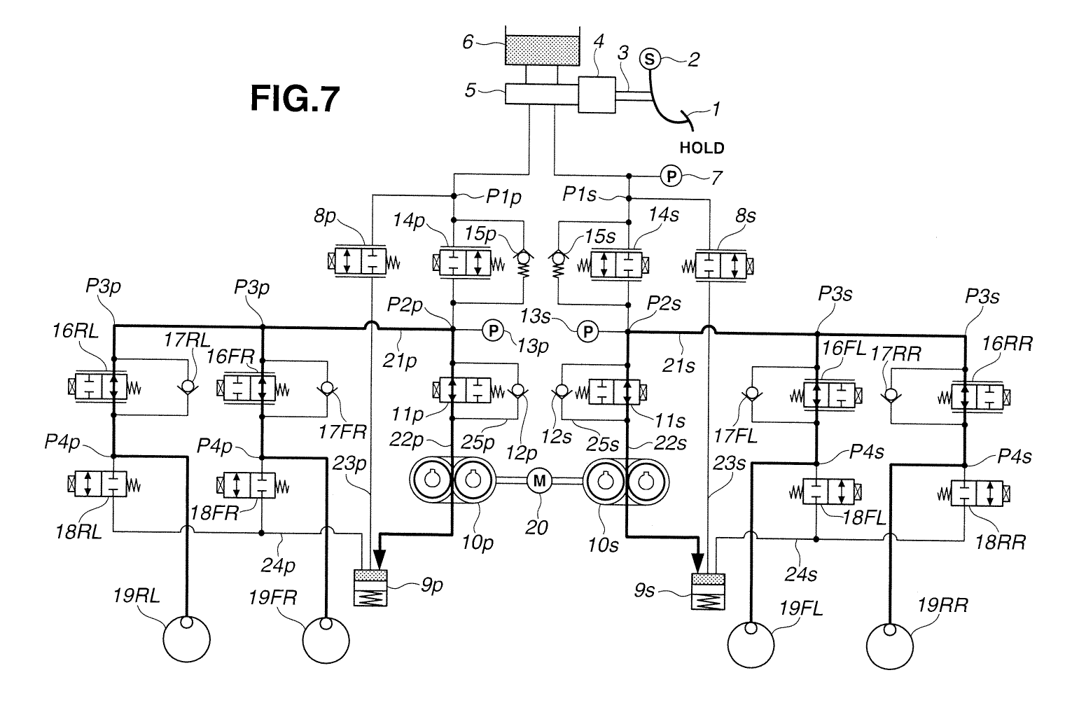

FIG. 7 is a drawing showing hydraulic paths during execution of the regenerative brake cooperative pressure decrease control. The regenerative brake cooperative pressure decrease control is a control that recovers the brake fluid generating the hydraulic pressure (the hydraulic braking force) which is equivalent to the braking force by the regenerative braking during execution of the regenerative braking, from the wheel cylinder 19 into the reservoir 9 by the pump 10. The gate-in valve 8, the gate-out valve 14, the pressure increase valve 16, the pressure decrease valve 18, the pump-out valve 11 and the pump 10 at this time are controlled as follows.
gate-in valve 8: closed
gate-out valve 14: closed
pressure increase valve 16: open
pressure decrease valve 18: closed
pump-out valve 11: open
pump 10: reverse rotation

The brake fluid is recovered in the following order: the wheel cylinder 19→the pressure increase valve 16→the pump-out valve 11→the pump 10→the reservoir 9.

(e) Pedal Stroke Generation Control

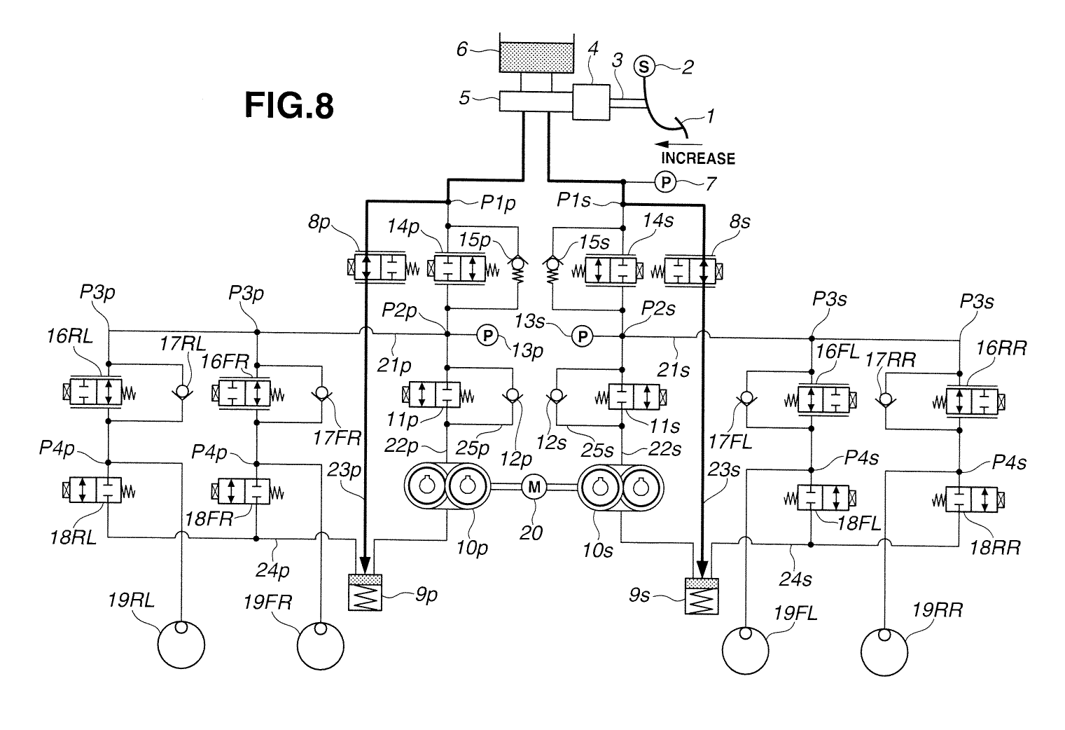

FIG. 8 is a drawing showing hydraulic paths during execution of the pedal stroke generation control. The pedal stroke generation control is a control that is performed in order to secure the stroke of the brake pedal 1 during execution of the regenerative braking. The gate-in valve 8, the gate-out valve 14, the pressure increase valve 16, the pressure decrease valve 18, the pump-out valve 11 and the pump 10 at this time are controlled as follows.
gate-in valve 8: open
gate-out valve 14: closed
pressure increase valve 16: open
pressure decrease valve 18: closed
pump-out valve 11: closed
pump 10: stop

The brake fluid is supplied in the following order: the master cylinder 5→the gate-in valve 8→the reservoir 9.

(Operation Mode)

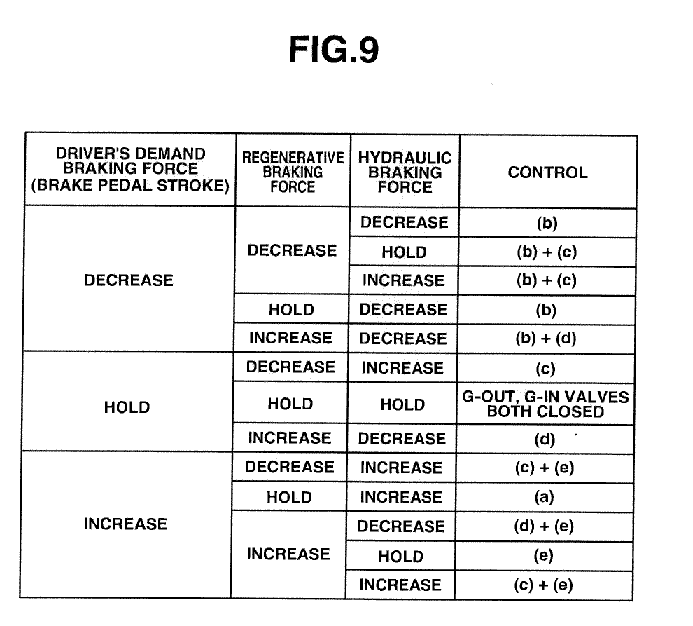

FIG. 9 is drawing showing operation modes which indicates which control of (a) to (e) is performed in accordance with a condition. The control is selected by the driver's braking demand (the stroke amount of the brake pedal 1), the regenerative braking force and the hydraulic braking force.

In a case of the driver's braking demand : “decrease”, the regenerative braking force: “decrease” and the hydraulic braking force: “decrease”, (b) the normal pressure decrease control is performed.

In a case of the driver's braking demand: “decrease”, the regenerative braking force: “decrease” and the hydraulic braking force: “hold”, (b) the normal pressure decrease control and (c) the regenerative brake cooperative pressure increase control are performed.

In a case of the driver's braking demand: “decrease”, the regenerative braking force: “decrease” and the hydraulic braking force: “increase”, (b) the normal pressure decrease control and (c) the regenerative brake cooperative pressure increase control are performed.

In a case of the driver's braking demand: “decrease”, the regenerative braking force: “hold” and the hydraulic braking force: “decrease”, (b) the normal pressure decrease control is performed.

In a case of the driver's braking demand: “decrease”, the regenerative braking force: “increase” and the hydraulic braking force: “decrease”, (b) the normal pressure decrease control and (d) the regenerative brake cooperative pressure decrease control are performed.

In a case of the driver's braking demand: “hold”, the regenerative braking force: “decrease” and the hydraulic braking force: “increase”, (c) the regenerative brake cooperative pressure increase control is performed.

In a case of the driver's braking demand: “hold”, the regenerative braking force: “hold” and the hydraulic braking force: “hold”, both the gate-out valve 14 and the gate-in valve 8 are closed, and the hydraulic pressure is held.

In a case of the driver's braking demand: “hold”, the regenerative braking force: “increase” and the hydraulic braking force: “decrease”, (d) the regenerative brake cooperative pressure decrease control is performed.

In a case of the driver's braking demand: “increase”, the regenerative braking force: “decrease” and the hydraulic braking force: “increase”, (c) the regenerative brake cooperative pressure increase control and (e) the pedal stroke generation control are performed.

In a case of the driver's braking demand: “increase”, the regenerative braking force: “hold” and the hydraulic braking force: “increase”, (a) the normal pressure increase control is performed.

In a case of the driver's braking demand: “increase”, the regenerative braking force: “increase” and the hydraulic braking force: “decrease”, (d) the regenerative brake cooperative pressure decrease control and (e) the pedal stroke generation control are performed.

In a case of the driver's braking demand: “increase”, the regenerative braking force: “increase” and the hydraulic braking force: “hold”, (e) the pedal stroke generation control is performed.

In a case of the driver's braking demand: “increase”, the regenerative braking force: “increase” and the hydraulic braking force: “increase”, (c) the regenerative brake cooperative pressure increase control and (e) the pedal stroke generation control are performed.

[Operation and Function]

### (Example of Operation)

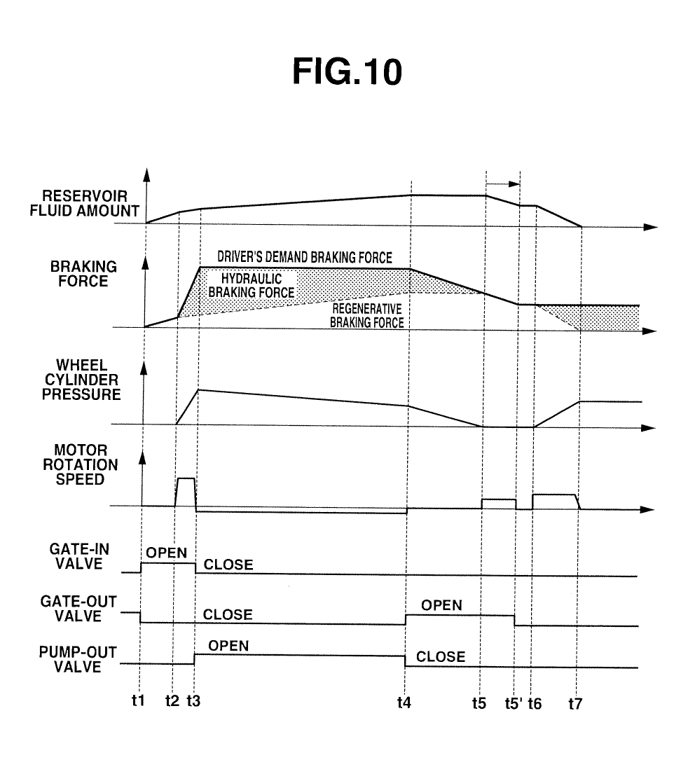

An example of operation of the control in the hydraulic braking system will be explained. FIG. 10 is a time chart showing the example of operation. When the driver's demand braking force is generated at time t1, first the braking force by the regenerative braking is produced or rises up. At this time, the gate-out valve 14 is closed and the gate-in valve 8 is opened, then the brake fluid is supplied from the master cylinder 5 into the reservoir 9, thereby securing the stroke of the brake pedal 1.

When the regenerative braking force can not respond to or follow the driver's demand braking force (i.e. when the driver's demand braking force can not be covered by the regenerative braking force) at time t2, the electric motor 20 is rotated in the forward rotation direction, and the wheel cylinder pressure is increased by supplying the brake fluid that is equivalent to a shortfall of the driver's demand braking force from the reservoir 9 to the wheel cylinder 19.

At time t3, although the driver's demand braking force is held, since the regenerative braking force increases, the electric motor 20 is rotated in the reverse rotation direction, and the wheel cylinder pressure is decreased by recovering the brake fluid that is equivalent to a redundant braking force from the wheel cylinder 19 into the reservoir 9. At this time, the gate-in valve 8 is closed and the pump-out valve 11 is opened.

When the driver's demand braking force decreases at time t4, the brake fluid in the wheel cylinder 19 is recovered to the reservoir tank 6. At this time, the pump-out valve 11 is closed and the gate-out valve 14 is opened.

When no wheel cylinder pressure remains at time t5, since a redundant brake fluid against the driver's demand braking force is generated in the reservoir 9, the electric motor 20 is rotated in the forward rotation direction, and the redundant brake fluid in the reservoir 9 is also sent to the reservoir tank 6. At this time, the gate-out valve 14 is opened.

When the driver's demand braking force becomes constant at time t5′, the electric motor 20 is stopped and the gate-out valve 14 is closed.

When the regenerative braking force starts to lack for the driver's demand braking force at time t6, the electric motor 20 is rotated in the forward rotation direction, and the wheel cylinder pressure is increased by supplying the brake fluid that is equivalent to the shortfall of the driver's demand braking force from the reservoir 9 to the wheel cylinder 19.

After time t7, both the gate-out valve 14 and the gate-in valve 8 are closed, and the wheel cylinder pressure is held.

(Enhancing of Efficiency of Regenerative Braking)

In the case of the hydraulic braking system, like the embodiment 1, in which the master cylinder 5 and the wheel cylinder 19 are connected by the hydraulic circuit, when attempting to change the hydraulic braking force in spite of holding the brake pedal 1, the master cylinder pressure changes, and this deteriorates brake pedal feeling.

In the related art apparatus, a control is performed so that a shortfall of the hydraulic braking force in the driver's demand braking force is covered or compensated by the regenerative braking force. That is, the hydraulic braking force is mainly used, and the regenerative braking force is used as an auxiliary or a supplemental braking force by the shortfall in the driver's demand braking force which occurs by the braking using only the hydraulic braking force.

Because of this, the regenerative braking can not adequately be performed, and there is a possibility that an efficient recovery of power will not be achieved during execution of the regenerative braking.

Thus, in the embodiment 1, the regenerative brake cooperative pressure increase control, in which when the regenerative braking system works, the gate-out valve 14 is controlled in a valve closing direction, and the brake fluid stored in the reservoir 9 is sent to the wheel cylinder 19 by the pump 10, then the wheel cylinder pressure is increased, is carried out.

In addition, the regenerative brake cooperative pressure decrease control, in which when the regenerative braking system works, the gate-out valve 14 is controlled in the valve closing direction, and the brake fluid in the wheel cylinder 19 is supplied to or flows into the reservoir 9 through the pump 10, then the wheel cylinder pressure is decreased, is carried out.

With these controls, it is possible to increase and decrease the wheel cylinder pressure regardless of the brake pedal stroke, and the hydraulic braking force can be controlled in accordance with the regenerative braking force. As a consequence, the regenerative braking can adequately be performed, and the efficient recovery of power can be achieved during execution of the regenerative braking.

Further, in the embodiment 1, the pedal stroke generation control, in which the brake fluid flowing out from the master cylinder 5 by the driver's brake operation is stored in the reservoir 9, is carried out.

With this control, it is possible to control the hydraulic braking force in accordance with the regenerative braking force regardless of the brake pedal stroke while securing the brake pedal stroke. Consequently, the regenerative braking can adequately be performed, and the efficient recovery of power can be achieved during execution of the regenerative braking.

(Miniaturization of Pressure Decrease Value)

To recover the brake fluid from the wheel cylinder 19 into the reservoir 9, the pressure decrease valve 18 is opened. When attempting to control the wheel cylinder pressure by the pressure decrease valve 18 of the ON/OFF valve, valve open/closure is continually repeated, and this continually generates a noise during the normal brake operation.

In order to reduce the noise, a proportional valve could be employed as the pressure decrease valve 18. However, cost of the proportional valve is high as compared with the ON/OFF valve. In addition, a size of a normally-closed type proportional valve, which is provided at a position where a relatively high pressure like the wheel cylinder pressure acts on, becomes large. This is because there is a need to use a strong spring to ensure a valve closed state even in the high pressure condition, and also a large-sized solenoid that is capable of control while overcoming this strong spring during a valve open control is necessary.

For this reason, in the embodiment 1, the gear pump that is capable of bidirectional rotation is employed as the pump 10. With this configuration, the pressure decrease valve 18 can be operated as the ON/OFF valve, and this can suppress the cost and allow the minimization of the valve.

(Suppression of Power Consumption)

By stopping the rotation of the pump 10 and rotating the pump 10 in the forward rotation direction all the time, backflow of the brake fluid can be prevented. However, in order to stop and rotate the pump 10 in the forward rotation direction, it is required to energize the electric motor 20 (to apply the power to the electric motor 20) all the time against the wheel cylinder pressure.

Thus, in the embodiment 1, the pump-out valve 11 and the one-way valve 12 allowing only the flow of the brake fluid in the direction in which the brake fluid is discharged from the pump 10 are provided. With this configuration, even when the electric motor 20 is not energized, the backflow of the brake fluid can be prevented, and the power consumption is suppressed.

(Returning Amount Control)

In the embodiment 1, the returning amount of the brake fluid, which flows into the reservoir 9 from the wheel cylinder 19 through the pump-out valve 11 and the pump 10 by the operation of the pump-out valve 11 in a valve opening direction, is controlled. More specifically, the brake fluid returning amount is controlled by giving the rotation drag to the pump 10. In other words, the brake fluid returning amount is controlled by controlling the rotation speed of the electric motor 20. With this control, the wheel cylinder pressure can be controlled by the pump 10.

(Miniaturization of Pump-Out Valve)

As same as the pressure decrease valve 18 described above, in the case of the proportional valve, its cost is high and its size becomes large.

Thus, in the embodiment 1, the normally-closed type ON/OFF valve is employed as the pump-out valve 11. With this, the cost of the pump-out valve 11 can be suppressed and minimization of the valve can be achieved.

(Reservoir Fluid Amount Control)

The normally-closed type gate-in valve 8 is arranged between the master cylinder 5 and the reservoir 9 on the third brake circuit 23. With this arrangement, the brake fluid amount in the reservoir 9 can be accurately controlled.

(Pump Discharge Amount Control)

In the embodiment 1, the required wheel cylinder pressure obtained on the basis of the driver's demand braking force is calculated, and the current value applied to the motor is adjusted or controlled on the basis of the wheel cylinder pressure and the required wheel cylinder pressure. With this control, a brake fluid discharge amount of the pump 10 can be accurately controlled, and the brake fluid (brake fluid pressure) can be supplied to the wheel cylinder 19 in accordance with the braking force that is lacking.

(Increase of Braking Force According to Increase of Demand Braking Force)

In the embodiment 1, when detecting a tendency toward increase of the driver's demand braking force by the brake pedal stroke sensor 2, the gate-out valve 14 is operated in the valve opening direction. With this operation, it is possible to increase the braking force in response to the increase of the driver's demand braking force.

(Decrease of Braking Force According to Decrease of Demand Braking Force)

In the embodiment 1, when detecting a tendency toward decrease of the driver's demand braking force by the brake pedal stroke sensor 2, the gate-out valve 14 is operated in the valve opening direction. With this operation, it is possible to decrease the braking force in response to the decrease of the driver's demand braking force.

(Securing of Braking Force when Regenerative Braking Force Decreases)

In the embodiment 1, in order to cover or compensate the braking force that corresponds to a decrease of the regenerative braking force produced by the regenerative braking system, the pump 10 sends the brake fluid flowing into and stored in the reservoir 9 to the wheel cylinder 19, thereby increasing the wheel cylinder pressure and securing the braking force. With this pump operation control, total braking force of the regenerative braking force and the hydraulic braking force is the driver's demand braking force. That is, the driver's demand braking force can be maintained by the combined total of the regenerative braking force and the hydraulic braking force.

(Securing of Brake Pedal Stroke)

In the embodiment 1, during the driver's brake operation, the gate-out valve 14 is controlled in the valve closing direction and the gate-in valve 8 is controlled in the valve opening direction, then the brake fluid flowing out from the master cylinder 5 flows and is stored in the reservoir 9. With this, even in a case where the braking force is secured by only the regenerative braking force (even in a case where the demand braking force is covered by only the regenerative braking force), it is possible to secure the brake pedal stroke, thereby increasing the brake pedal feeling.

(Ensuring of Sealing Performance of Pump)

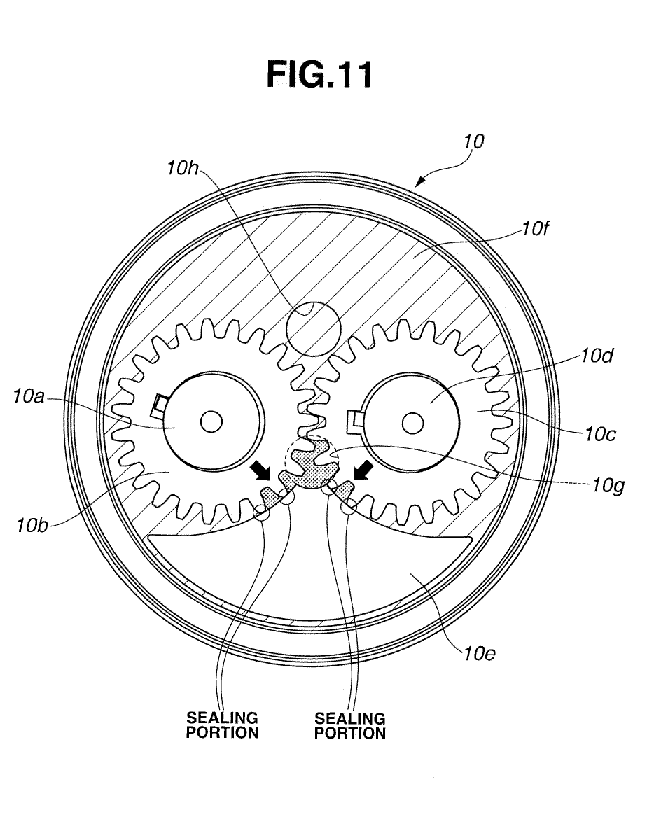

FIG. 11 is a sectional view of the pump 10. The pump 10 is formed by a drive shaft 10a that rotates integrally with a rotation shaft of the electric motor 20, a drive gear 10b that is fixed to the drive shaft 10a and rotates integrally with the drive shaft 10a, a driven gear 10c that engages with the drive gear 10b, a driven shaft 10d to which the driven gear 10c is fixed and which rotates integrally with the driven gear 10c, a sealing block 10e that seals tooth edges of the drive and driven gears 10b and 10c, and a housing 10f that houses therein these components.

In the housing 10f, a suction hole 10g is formed in a space defined or enclosed with the sealing block 10e and the drive and driven gears 10b and 10c. This suction hole 10g is connected to the third brake circuit 23. Further, in the housing 10f, a discharge hole 10h is formed at outer circumferential sides of the drive and driven gears 10b and 10c. This discharge hole 10h is connected to the second brake circuit 22.

When both teeth of the drive and driven gears 10b and 10c are engaged and pass the suction hole 10g by the gear rotation, the brake fluid is supplied to the pump 10 (namely that the pump 10 sucks the brake fluid in). Then when the drive and driven gears 10b and 10c rotate with the both teeth sealed by the sealing block 10e, the brake fluid is supplied to the discharge hole 10h side (namely that the pump 10 discharges the brake fluid).

When the pump 10 rotates in the forward rotation direction, an area shown by oblique lines in FIG. 11 becomes a high pressure area, while an area shown by dots becomes a low pressure area. Thus the drive and driven gears 10b and 10c are pressed against the sealing block 10e (in arrow directions in FIG. 11), then sealing portions are formed between the tooth edges of the drive and driven gears 10b and 10c and the sealing block 10e.

If the area shown by dots becomes the high pressure area and the area shown by oblique lines becomes the low pressure area, since the drive and driven gears 10b and 10c are pressed in a direction moving away from the sealing block 10e, the tooth edges of the drive and driven gears 10b and 10c separate from the sealing block 10e, the sealing performance can not therefore be ensured.

Thus, in the embodiment 1, when the brake fluid amount in the reservoir 9 increases and the pressure in the reservoir 9 becomes higher than the discharge pressure detected by the discharge pressure sensor 13, the reverse rotation of the electric motor 20 is forbidden.

With this control, it is possible to prevent the hydraulic pressure at the suction hole 10g side from being higher than the hydraulic pressure at the discharge hole 10h side, thereby ensuring the sealing performance of the pump 10.

Next, effects will be explained. The brake control apparatus of the embodiment 1 has the following effects.

(1) The brake control apparatus used for the vehicle having the regenerative braking system, has: the pump 10 provided in the brake circuit and driven by the electric motor 20; the first brake circuit 21 connecting the master cylinder 5 that produces the brake fluid pressure by driver's brake operation and the wheel cylinder 19 that is configured so that the brake fluid pressure acts on and the wheel cylinder pressure is increased and decreased; the second brake circuit 22 connecting the first brake circuit 21 and the discharge side of the pump 10; the gate-out valve 14 provided at the master cylinder 5 side with respect to the connecting point (P2) of the second brake circuit 22, on the first brake circuit 21; the third brake circuit 23 connecting the point (P1) positioned at the master cylinder 5 side with respect to the gate-out valve 14 on the first brake circuit 21 and the suction side of the pump 10; the reservoir 9 provided at the suction side of the pump 10 on the third brake circuit 23 and capable of storing the brake fluid that flows out from the master cylinder 5; and the hydraulic pressure control unit 31 having: the pedal stroke generation controlling section (the brake fluid storage controlling section) 31a that stores the brake fluid flowing out from the master cylinder 5 by the driver's brake operation in the reservoir 9; the regenerative brake cooperative pressure increase controlling section 31b that, when the regenerative braking system operates, controls the gate-out valve 14 in the valve closing direction and supplies the brake fluid stored in the reservoir 9 to the wheel cylinder 19 by the pump 10 then increases the wheel cylinder pressure; and the regenerative brake cooperative pressure decrease controlling section 31c that, when the regenerative braking system operates, controls the gate-out valve 14 in the valve closing direction and pours the brake fluid in the wheel cylinder 19 into the reservoir 9 through the pump 10 then decreases the wheel cylinder pressure.

Thus, the regenerative braking can adequately be performed, and the efficient recovery of power can be achieved during execution of the regenerative braking.

(2) The pump 10 is the gear pump that is capable of bidirectional rotation.

Thus, the ON/OFF valve can be used as the pressure decrease valve 18, and this brings not only cost reduction but also size reduction.

(3) The brake control apparatus further has the pump-out valve 11 arranged on the second brake circuit 22; and the discharge oil passage 25 provided parallel to the second brake circuit 22 and having the one-way valve 12 that allows only the flow of the brake fluid in the direction in which the brake fluid is discharged from the pump 10.

Thus, even when the electric motor 20 is not energized, the backflow of the brake fluid can be prevented, and the power consumption can be suppressed

(4) The regenerative brake cooperative pressure decrease controlling section 31c has the brake fluid returning amount controlling section 31h that controls the returning amount of the brake fluid which pours into the reservoir 9 from the wheel cylinder 19 through the pump-out valve 11 and the pump 10 by the operation of the pump-out valve 11 in the valve opening direction.

It is therefore possible to control the wheel cylinder pressure by the pump 10.

(5) The brake fluid returning amount controlling section 31h gives the rotation drag to the pump 10.

It is therefore possible to control the wheel cylinder pressure by the pump 10.

(6) The brake fluid returning amount controlling section 31h controls the rotation speed of the electric motor 20.

It is therefore possible to control the wheel cylinder pressure by the pump 10.

(7) The pump-out valve 11 is the normally-closed type ON/OFF valve.

Thus, not only cost reduction but also size reduction of the pump-out valve 11 can be achieved.

(8) The normally-closed type gate-in valve 8 is arranged between the master cylinder 5 and the reservoir 9 on the third brake circuit 23.

With this arrangement, the brake fluid amount in the reservoir 9 can be accurately controlled.

(9) The brake control apparatus further has the brake pedal stroke sensor 2 that detects the brake operation state of the driver; the demand braking force calculating section 30a that calculates the demand braking force of the driver from the detected brake operation state; the wheel cylinder pressure calculating section 31f that calculates the hydraulic pressure of the wheel cylinder 19; and the required wheel cylinder pressure calculating section 30c that calculates the required wheel cylinder pressure obtained on the basis of the driver's demand braking force calculated by the demand braking force calculating section 30a, and the hydraulic pressure control unit 31 has the motor drive controlling section 31g that controls the current value applied to the electric motor 20 on the basis of the calculated wheel cylinder pressure and the calculated required wheel cylinder pressure.

Thus, the brake fluid discharge amount of the pump 10 can be accurately controlled, and the brake fluid (brake fluid pressure) can be supplied to the wheel cylinder 19 in accordance with the braking force that is lacking.

(10) The hydraulic pressure control unit 31 has the normal pressure increase controlling section 31d that, when detecting the tendency toward increase of the driver's demand braking force by the brake pedal stroke sensor 2, operates the gate-out valve 14 in the valve opening direction.

It is therefore possible to increase the braking force in response to the increase of the driver's demand braking force.

(11) The hydraulic pressure control unit 31 has the normal pressure decrease controlling section 31e that, when detecting the tendency toward decrease of the driver's demand braking force by the brake pedal stroke sensor 2, operates the gate-out valve 14 in the valve opening direction.

It is possible to decrease the braking force in response to the decrease of the driver's demand braking force.

(12) The pump 10 sends the brake fluid flowing into and stored in the reservoir 9 to the wheel cylinder 19 to compensate the braking force that corresponds to the decrease of the regenerative braking force produced by the regenerative braking system, and increases the wheel cylinder pressure for securing the braking force.

With this operation, total braking force of the regenerative braking force and the hydraulic braking force is the driver's demand braking force. That is, the driver's demand braking force can be maintained by the combined total of the regenerative braking force and the hydraulic braking force.

(13) The hydraulic pressure control unit 31 has the pedal stroke generating section (the pedal stroke generation controlling section) 31a that, during the driver's brake operation, controls the gate-out valve 14 in the valve closing direction and controls the gate-in valve 8 in the valve opening direction and pours the brake fluid flowing out from the master cylinder 5 into the reservoir 9.

Thus, even in the case where the braking force is secured by only the regenerative braking force (even in the case where the demand braking force is covered by only the regenerative braking force), it is possible to secure the brake pedal stroke, thereby increasing the brake pedal feeling.

### Embodiment 2

A hydraulic braking system of an embodiment 2 will be explained. In the embodiment 1, during execution of the pedal stroke generation control, the gate-in valve 8 is opened and the gate-out valve 14 is closed, then the brake fluid is supplied to the reservoir 9 through the third brake circuit 23. However, a brake fluid path (hydraulic path) of the embodiment 2 differs from that of the embodiment 1.

[Operation of Hydraulic Braking System]

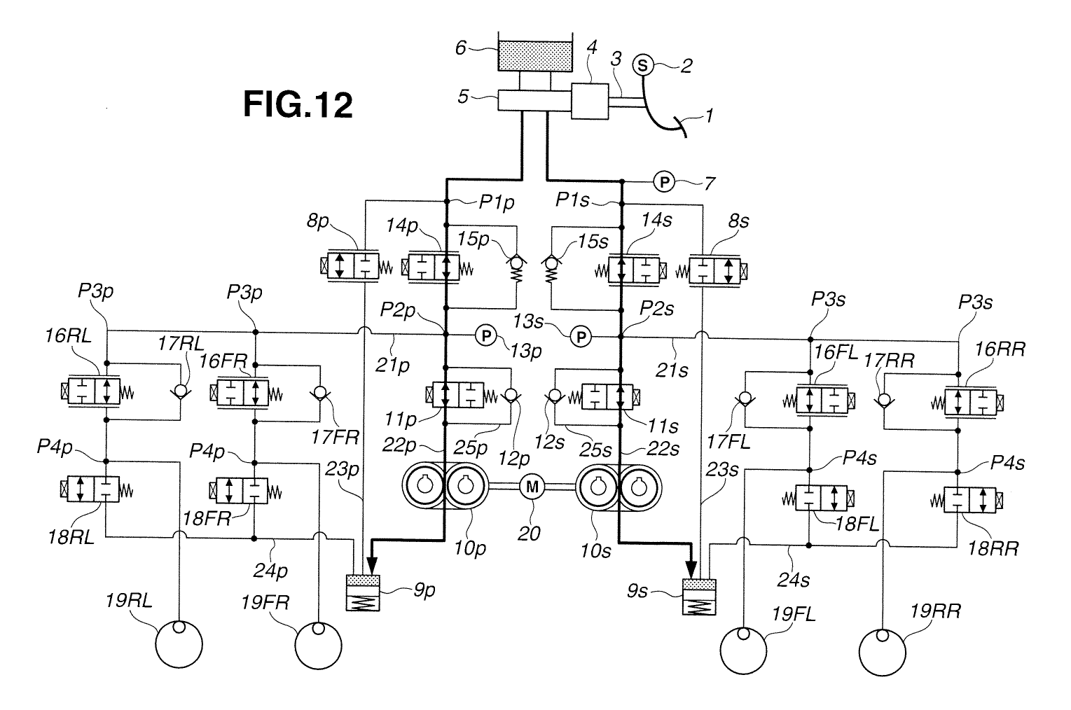

FIG. 12 is a drawing showing the hydraulic paths during execution of the pedal stroke generation control. In the pedal stroke generation control, the gate-in valve 8, the gate-out valve 14, the pressure increase valve 16, the pressure decrease valve 18, the pump-out valve 11 and the pump 10 are controlled as follows.
gate-in valve 8: closed
gate-out valve 14: open
pressure increase valve 16: open
pressure decrease valve 18: closed
pump-out valve 11: open
pump 10: reverse rotation

The brake fluid is supplied in the following order: the master cylinder 5 the gate-out valve 14 the pump 10 the reservoir 9. Although the electric motor 20 is not energized, the pump 10 rotates in the reverse rotation direction by the drag of the brake fluid pressure (brake fluid).

[Function]

In the embodiment 2, during the driver's brake operation, the gate-out valve 14 and the pump-out valve 11 are controlled in the valve opening direction, then the brake fluid flowing out from the master cylinder 5 flows and is stored in the reservoir 9. With this, even in a case where the braking force is secured by only the regenerative braking force (even in a case where the demand braking force is covered by only the regenerative braking force), it is possible to secure the brake pedal stroke, thereby increasing the brake pedal feeling.

[Effect]

(14) The pedal stroke generation controlling section 31a performs the control so that, during the driver's brake operation, the gate-out valve 14 and the pump-out valve 11 are controlled in the valve opening direction, then the brake fluid flowing out from the master cylinder 5 flows and is stored in the reservoir 9.

Thus, even in the case where the braking force is secured by only the regenerative braking force (even in the case where the demand braking force is covered by only the regenerative braking force), it is possible to secure the brake pedal stroke, thereby increasing the brake pedal feeling.

### Embodiment 3

A hydraulic braking system of an embodiment 3 will be explained. In the embodiment 1, the gate-in valve 8 is provided. However, in the embodiment 3, the gate-in valve 8 is not provided, but a check valve 26 is provided at the reservoir 9.

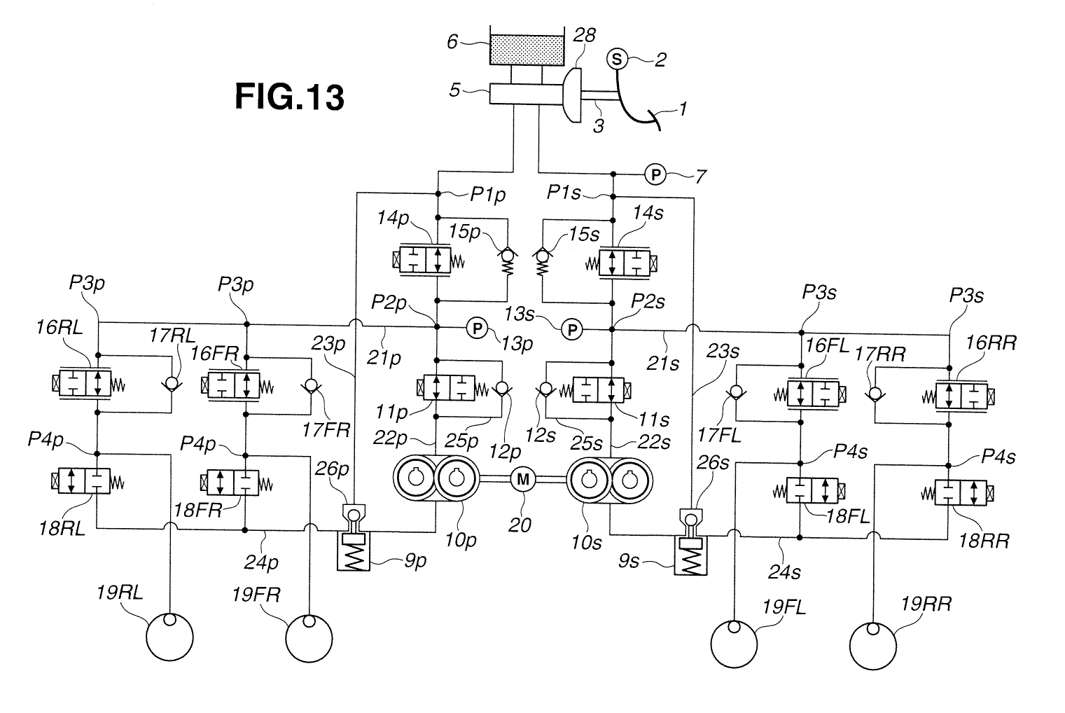

FIG. 13 is a hydraulic circuit of the hydraulic braking system. The reservoir 9 has the check valve 26. The check valve 26 closes when a predetermined amount of the brake fluid is stored in the reservoir 9 or when a pressure of the third brake circuit 23 becomes a high pressure that exceeds a predetermined hydraulic pressure. By forbidding flow of the brake fluid into the reservoir 9, the high pressure is prevented from being applied to the suction hole 10g of the pump 10.

The check valve 26 allows the flow of the brake fluid into the reservoir 9 when the pump 10 operates and the pressure of the third brake circuit 23 becomes low.

In the embodiment 3, a negative pressure booster unit 28 is further provided at the top end of the brake rod 3 attached to the brake pedal 1. The negative pressure booster unit 28 provides thrust or propulsion to the brake rod 3 using an engine negative pressure, and assists the driver with the depression of the brake pedal upon his/her braking operation. This negative pressure booster unit 28 is configured so that the negative pressure booster unit 28 does not work until the stroke amount of the brake pedal 1 reaches a predetermined stroke amount (loss-stroke).

[Effect]

(15) The reservoir 9 is provided with the check valve 26. Therefore, it is not required to provide the gate-in valve 8 on the third brake circuit 23, and the system can be simplified.

### Embodiment 4

A hydraulic braking system of an embodiment 4 will be explained. In the embodiment 1, the pump-out valve 11 is arranged on the second brake circuit 22. However, in the embodiment 4, a setting position of the pump-out valve 11 is different from that of the embodiment 1.

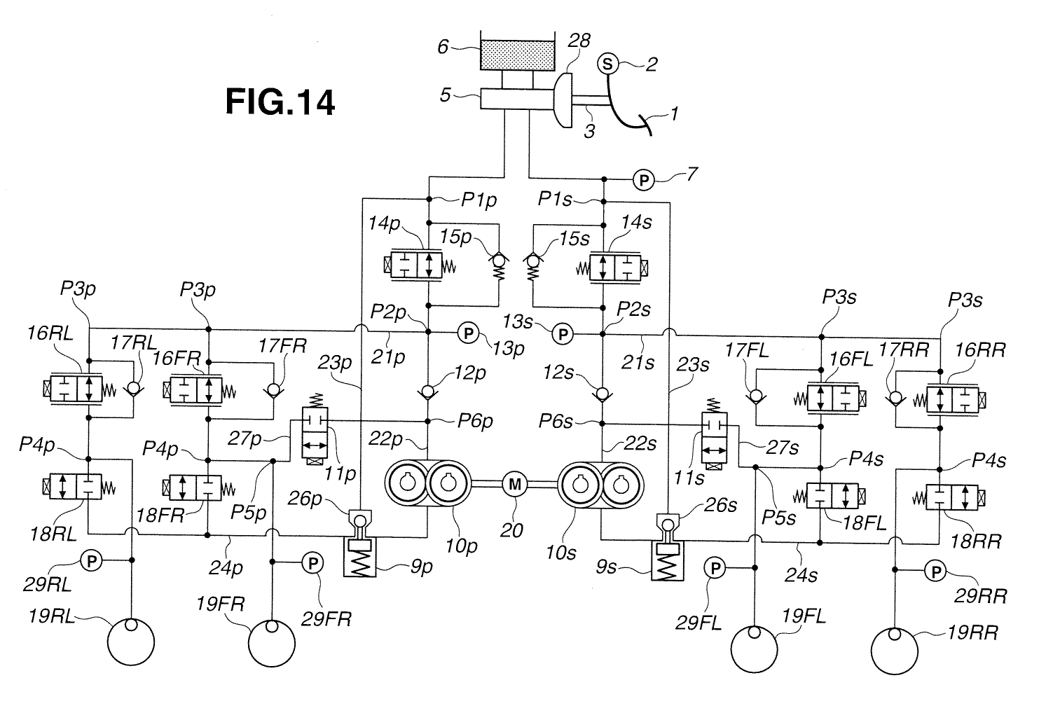

FIG. 14 is a hydraulic circuit of the hydraulic braking system. As can be seen in the drawing, a fifth brake circuit 27 that connects a connecting point (P5) positioned between the pressure increase valves 16FR, 16FL at the front wheel side on the first brake circuit 21 and the respective wheel cylinders 19FR, 19FL to the second brake circuit 22 is provided. Then the pump-out valve 11 is arranged on this fifth brake circuit 27. Further, the one-way valve 12 is arranged on an opposite side to the pump 10 with respect to a connecting point (P6) that connects the fifth brake circuit 27 and the second brake circuit 22.

In addition, each wheel cylinder 19 is provided with a wheel cylinder pressure sensor 29 that detects the wheel cylinder pressure.

[Operation of Hydraulic Braking System]

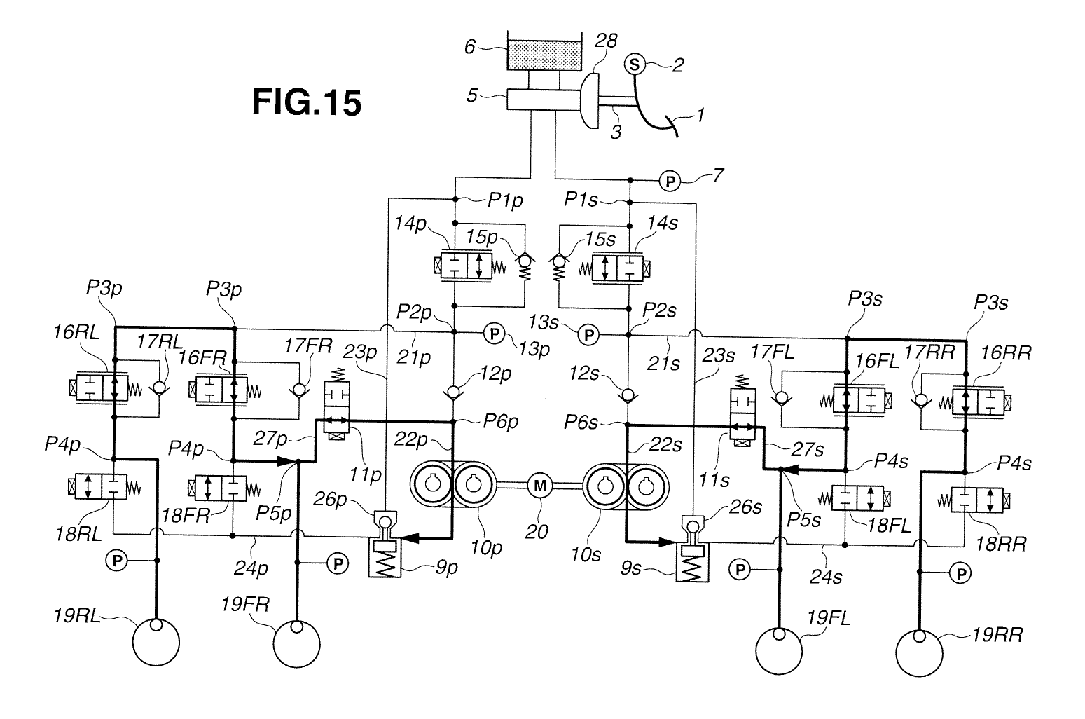

FIG. 15 is a drawing showing hydraulic paths during execution of the regenerative brake cooperative pressure decrease control. As described above, the regenerative brake cooperative pressure decrease control is the control that recovers the brake fluid generating the hydraulic pressure (the hydraulic braking force) which is equivalent to the braking force by the regenerative braking during execution of the regenerative braking, from the wheel cylinder 19 into the reservoir 9 by the pump 10. The gate-out valve 14, the pressure increase valve 16, the pressure decrease valve 18, the pump-out valve 11 and the pump 10 at this time are controlled as follows.
gate-out valve 14: closed
pressure increase valve 16: open
pressure decrease valve 18: closed
pump-out valve 11: open
pump 10: reverse rotation

The brake fluid is recovered in the following order: the wheel cylinder 19→the pressure increase valve 16→the pump-out valve 11→the pump 10→the reservoir 9.

[Effect]

(16) The fifth brake circuit 27 that connects the connecting point positioned between the pressure increase valves 16FR, 16FL at the front wheel side on the first brake circuit 21 and the respective wheel cylinders 19FR, 19FL to the second brake circuit 22 is provided, then the pump-out valve 11 is arranged on this fifth brake circuit 27.

When the gate-out valve 14 is closed, by the function of the relief valve 15, a pressure of P2 on the brake circuit can be a lower pressure than a pressure of P1. Therefore, in this state, by rotating the pump 10 in the reverse rotation direction and opening the pump-out valve 11, it is possible to recover the brake fluid in the wheel cylinder 19 into the reservoir 9.

### Other Embodiments

The embodiments of the present invention has been explained above on the basis of the embodiments 1 to 4.

However, the configuration or system of the present invention is not limited to the embodiments 1 to 4.

For instance, in the embodiment 1, the electric booster unit 4 is used. However, in the case of the hybrid vehicle, the negative pressure booster unit can be employed.

Further, in the embodiment 1, the regenerative brake cooperative pressure increase control is performed so as to open the pump-out valve 11. However, the pump-out valve 11 could be kept controlled in the valve closed state.

The above embodiments can produce advantageous effects as described above. In addition to that, modified examples having substantially the same effects as the above embodiments will be explained below.

(a) In the brake control apparatus, the brake fluid returning amount controlling section 31h controls the rotation speed of the electric motor 20.

It is therefore possible to control the wheel cylinder pressure by the pump 10.

(b) In the brake control apparatus, the pump-out valve 11 is the normally-closed type ON/OFF valve.

Thus, not only cost reduction but also size reduction of the pump-out valve 11 can be achieved.

(c) In the brake control apparatus, the normally-closed type gate-in valve 8 is arranged between the master cylinder 5 and the reservoir 9 on the third brake circuit 23.

With this arrangement, the brake fluid amount in the reservoir 9 can be accurately controlled.

(d) In the brake control apparatus, the brake control apparatus further has the brake pedal stroke sensor 2 that detects the brake operation state of the driver; the demand braking force calculating section 30a that calculates the demand braking force of the driver from the detected brake operation state; the wheel cylinder pressure calculating section 31f that calculates the hydraulic pressure of the wheel cylinder 19; and the required wheel cylinder pressure calculating section 30c that calculates the required wheel cylinder pressure obtained on the basis of the driver's demand braking force calculated by the demand braking force calculating section 30a, and the hydraulic pressure control unit 31 has the motor drive controlling section 31g that controls the current value applied to the electric motor 20 on the basis of the calculated wheel cylinder pressure and the calculated required wheel cylinder pressure.

Thus, the brake fluid discharge amount of the pump 10 can be accurately controlled, and the brake fluid (brake fluid pressure) can be supplied to the wheel cylinder 19 in accordance with the braking force that is lacking.

(e) In the brake control apparatus, the hydraulic pressure control unit 31 has the normal pressure increase controlling section 31d that, when detecting the tendency toward increase of the driver's demand braking force by the brake pedal stroke sensor (the brake operation state detecting section) 2, operates the gate-out valve 14 in the valve opening direction.

It is therefore possible to increase the braking force in response to the increase of the driver's demand braking force.

(f) In the brake control apparatus, the hydraulic pressure control unit 31 has the normal pressure decrease controlling section 31e that, when detecting the tendency toward decrease of the driver's demand braking force by the brake pedal stroke sensor (the brake operation state detecting section) 2, operates the gate-out valve 14 in the valve opening direction.

It is possible to decrease the braking force in response to the decrease of the driver's demand braking force.

(g) In the brake control apparatus, the pump 10 sends the brake fluid flowing into and stored in the reservoir 9 to the wheel cylinder 19 to compensate the braking force that corresponds to the decrease of the regenerative braking force produced by the regenerative braking system, and increases the wheel cylinder pressure for securing the braking force.

With this operation, total braking force of the regenerative braking force and the hydraulic braking force is the driver's demand braking force. That is, the driver's demand braking force can be maintained by the combined total of the regenerative braking force and the hydraulic braking force.

(h) In the brake control apparatus, the hydraulic pressure control unit 31 has the pedal stroke generating section (the pedal stroke generation controlling section) 31a that, during the driver's brake operation, controls the gate-out valve 14 in the valve closing direction and controls the gate-in valve 8 in the valve opening direction and pours the brake fluid flowing out from the master cylinder 5 into the reservoir 9.

Thus, even in the case where the braking force is secured by only the regenerative braking force (even in the case where the demand braking force is covered by only the regenerative braking force), it is possible to secure the brake pedal stroke, thereby increasing the brake pedal feeling.

(i) In the brake control apparatus, the hydraulic pressure control unit 31 has the pedal stroke generating section (the pedal stroke generation controlling section) 31a that, during the driver's brake operation, controls the gate-out valve 14 and the pump-out valve 11 in the valve opening direction and pours the brake fluid flowing out from the master cylinder 5 into the reservoir 9.

Thus, even in the case where the braking force is secured by only the regenerative braking force (even in the case where the demand braking force is covered by only the regenerative braking force), it is possible to secure the brake pedal stroke, thereby increasing the brake pedal feeling.

(j) The brake control apparatus used for the vehicle having the regenerative braking system, has: the pump 10 provided in the brake circuit and driven by the electric motor 20; the first brake circuit 21 connecting the master cylinder 5 that produces the brake fluid pressure by driver's brake operation and the wheel cylinder 19 that is configured so that the brake fluid pressure acts on and the wheel cylinder pressure is increased and decreased; the second brake circuit 22 connecting the first brake circuit 21 and the discharge side of the pump 10; the gate-out valve 14 provided at the master cylinder 5 side with respect to the connecting point (P2) of the second brake circuit 22, on the first brake circuit 21; the third brake circuit 23 connecting the point (P1) positioned at the master cylinder 5 side with respect to the gate-out valve 14 on the first brake circuit 21 and the suction side of the pump 10; the reservoir 9 provided at the suction side of the pump 10 on the third brake circuit 23 and capable of storing the brake fluid that flows out from the master cylinder 5; the pump-out valve 11 arranged on the second brake circuit 22; the discharge oil passage 25 provided parallel to the second brake circuit 22 and having the one-way valve 12 that allows only the flow of the brake fluid in the direction in which the brake fluid is discharged from the pump 10; and the control unit 31 having: the regenerative brake cooperative pressure increase controlling section 31b that, when the regenerative braking system operates, supplies the brake fluid stored in the reservoir 9 to the wheel cylinder 19 by the pump 10; and the regenerative brake cooperative pressure decrease controlling section 31c that, when the regenerative braking system operates, pours the brake fluid supplied to the wheel cylinder 19 into the reservoir 9 through the pump-out valve 11 and the pump 10.

Thus, the regenerative braking can adequately be performed, and the efficient recovery of power can be achieved during execution of the regenerative braking.

(k) In the brake control apparatus, the control unit 31 has the brake fluid storage controlling section 31a that operates the gate-out valve 14 in the valve closing direction and stores the brake fluid flowing out from the master cylinder 5 by the driver's brake operation in the reservoir 9.

it is therefore possible to secure the brake pedal stroke and to increase the brake pedal feeling.

(l) In the brake control apparatus, the regenerative brake cooperative pressure decrease controlling section 31c has the brake fluid returning amount controlling section 31h that controls the returning amount of the brake fluid which pours into the reservoir 9 from the wheel cylinder 19 through the pump-out valve 11 and the pump 10 by the operation of the pump-out valve 11 in the valve opening direction, and the brake fluid returning amount controlling section 31h controls the rotation speed of the electric motor 20.

It is therefore possible to control the wheel cylinder pressure by the pump 10.

(m) The brake control apparatus further has the brake pedal stroke sensor 2 that detects the brake operation state of the driver; the demand braking force calculating section 30a that calculates the demand braking force of the driver from the detected brake operation state; the wheel cylinder pressure calculating section 31f that calculates the hydraulic pressure of the wheel cylinder 19; and the required wheel cylinder pressure calculating section 30c that calculates the required wheel cylinder pressure obtained on the basis of the driver's demand braking force calculated by the demand braking force calculating section 30a, and the hydraulic pressure control unit 31 has the motor drive controlling section 31g that controls the current value applied to the electric motor 20 on the basis of the calculated wheel cylinder pressure and the calculated required wheel cylinder pressure.

Thus, the brake fluid discharge amount of the pump 10 can be accurately controlled, and the brake fluid (brake fluid pressure) can be supplied to the wheel cylinder 19 in accordance with the braking force that is lacking.

(n) In the brake control apparatus, when detecting the tendency toward increase of the driver's demand braking force by the brake operation state detecting section 2, the control unit 31 operates the gate-out valve 14 in the valve opening direction, and when detecting the tendency toward decrease of the driver's demand braking force by the brake operation state detecting section 2, the control unit 31 operates the gate-out valve 14 in the valve opening direction.

It is therefore possible to increase the braking force in response to the increase of the driver's demand braking force, and possible to decrease the braking force in response to the decrease of the driver's demand braking force.

(o) The method for controlling brake of the brake apparatus used for the vehicle having the regenerative braking system, the brake apparatus having: the reservoir 9 storing the brake fluid that flows out from the master cylinder 5 by driver's brake operation; and the pump 10 capable of bidirectional rotation, the method has: pumping up the brake fluid stored in the reservoir 9 by the rotation in the forward rotation direction of the pump 10 and supplying the brake fluid to the wheel cylinder 19; and returning the brake fluid in the wheel cylinder 19 to the reservoir 9 by the rotation in the reverse rotation direction of the pump 10 in response to increase of the regenerative braking force produced by the regenerative braking system.

Thus, the regenerative braking can adequately be performed, and the efficient recovery of power can be achieved during execution of the regenerative braking.

The entire contents of Japanese Patent Application No. 2011-185625 filed on Aug. 29, 2011 are incorporated herein by reference.

Although the invention has been described above by reference to certain embodiments of the invention, the invention is not limited to the embodiments described above. Modifications and variations of the embodiments described above will occur to those skilled in the art in light of the above teachings. The scope of the invention is defined with reference to the following claims.

What is claimed is:

1. A brake control apparatus used for a vehicle having a regenerative braking system, comprising:
a pump provided in a brake circuit and driven by an electric motor;
a first brake circuit connecting a master cylinder that produces a brake fluid pressure by driver's brake operation and a wheel cylinder that is configured so that the brake fluid pressure acts on and a wheel cylinder pressure is increased and decreased;
a second brake circuit connecting the first brake circuit and a discharge side of the pump;
a gate-out valve provided at a master cylinder side with respect to a connecting point of the second brake circuit, on the first brake circuit;
a third brake circuit connecting a point positioned at the master cylinder side with respect to the gate-out valve on the first brake circuit and a suction side of the pump;
a reservoir provided at the suction side of the pump on the third brake circuit and capable of storing a brake fluid that flows out from the master cylinder; and
a control unit having:
a brake fluid storage controlling section that stores the brake fluid flowing out from the master cylinder by the driver's brake operation in the reservoir;
a pressure increase controlling section that controls the gate-out valve in a valve closing direction and supplies the brake fluid stored in the reservoir to the wheel cylinder by the pump then increases the wheel cylinder pressure; and
a pressure decrease controlling section that, when the regenerative braking system operates, pours the brake fluid supplied to and pressurized in the wheel cylinder into the reservoir through the pump then decreases the wheel cylinder pressure.

2. The brake control apparatus as claimed in claim 1, wherein:
the pump is a gear pump that is capable of bidirectional rotation.

3. The brake control apparatus as claimed in claim 2, further comprising:
a pump-out valve arranged on the second brake circuit; and
a discharge oil passage provided parallel to the second brake circuit and having a one-way valve that allows only a flow of the brake fluid in a direction in which the brake fluid is discharged from the pump.

4. The brake control apparatus as claimed in claim 3, wherein:
the pressure decrease controlling section has a brake fluid returning amount controlling section that controls a returning amount of the brake fluid which pours into the reservoir from the wheel cylinder through the pump-out valve and the pump by an operation of the pump-out valve in a valve opening direction.

5. The brake control apparatus as claimed in claim 4, wherein:
the brake fluid returning amount controlling section gives a rotation drag to the pump.

6. The brake control apparatus as claimed in claim 5, wherein:
the brake fluid returning amount controlling section controls a rotation speed of the electric motor.

7. The brake control apparatus as claimed in claim 3, wherein:
the pump-out valve is a normally-closed type ON/OFF valve.

8. The brake control apparatus as claimed in claim 3, wherein:
a normally-closed type gate-in valve is provided between the master cylinder and the reservoir on the third brake circuit.

9. The brake control apparatus as claimed in claim 3, further comprising:
a brake operation state detecting section that detects a brake operation state of the driver;
a demand braking force calculating section that calculates a demand braking force of the driver from the detected brake operation state;
a wheel cylinder pressure calculating section that calculates a hydraulic pressure of the wheel cylinder; and
a required wheel cylinder pressure calculating section that calculates a required wheel cylinder pressure obtained on the basis of the driver's demand braking force calculated by the demand braking force calculating section, and wherein
the control unit has a motor driving section that controls a current value applied to the electric motor on the basis of the calculated wheel cylinder pressure and the calculated required wheel cylinder pressure.

10. The brake control apparatus as claimed in claim 9, wherein:
when detecting a tendency toward increase of the driver's demand braking force by the brake operation state detecting section, the control unit operates the gate-out valve in the valve opening direction.

11. The brake control apparatus as claimed in claim 9, wherein:
when detecting a tendency toward decrease of the driver's demand braking force by the brake operation state detecting section, the control unit operates the gate-out valve in the valve opening direction.

12. The brake control apparatus as claimed in claim 4, wherein:
the pump sends the brake fluid flowing into and stored in the reservoir to the wheel cylinder to compensate the braking force that corresponds to a decrease of a regenerative braking force produced by the regenerative braking system, and increases the wheel cylinder pressure.

13. The brake control apparatus as claimed in claim 8, wherein:
the control unit has a pedal stroke generating section that, during the driver's brake operation, controls the gate-out valve in the valve closing direction and controls the gate-in valve in the valve opening direction and pours the brake fluid flowing out from the master cylinder into the reservoir.

14. The brake control apparatus as claimed in claim 3, wherein:
the control unit has a pedal stroke generating section that, during the driver's brake operation, controls the gate-out valve and the pump-out valve in the valve opening direction and pours the brake fluid flowing out from the master cylinder into the reservoir.

15. A brake control apparatus used for a vehicle having a regenerative braking system, comprising:
a pump provided in a brake circuit and driven by an electric motor;
a first brake circuit connecting a master cylinder that produces a brake fluid pressure by driver's brake operation and a wheel cylinder that is configured so that the brake fluid pressure acts on and a wheel cylinder pressure is increased and decreased;
a second brake circuit connecting the first brake circuit and a discharge side of the pump;
a gate-out valve provided at a master cylinder side with respect to a connecting point of the second brake circuit, on the first brake circuit;
a third brake circuit connecting a point positioned at the master cylinder side with respect to the gate-out valve on the first brake circuit and a suction side of the pump;
a reservoir provided at the suction side of the pump on the third brake circuit and capable of storing a brake fluid that flows out from the master cylinder;
a pump-out valve arranged on the second brake circuit;
a discharge oil passage provided parallel to the second brake circuit and having a one-way valve that allows only a flow of the brake fluid in a direction in which the brake fluid is discharged from the pump; and
a control unit having:
a pressure increase controlling section that supplies the brake fluid stored in the reservoir to the wheel cylinder by the pump; and
a pressure decrease controlling section that, when the regenerative braking system operates, pours the brake fluid supplied to the wheel cylinder into the reservoir through the pump-out valve and the pump.

16. The brake control apparatus as claimed in claim 15, wherein:
the control unit has a brake fluid storage controlling section that operates the gate-out valve in a valve closing direction and stores the brake fluid flowing out from the master cylinder by the driver's brake operation in the reservoir.

17. The brake control apparatus as claimed in claim 16, wherein:
the pressure decrease controlling section has a brake fluid returning amount controlling section that controls a returning amount of the brake fluid which pours into the reservoir from the wheel cylinder through the pump-out valve and the pump by an operation of the pump-out valve in a valve opening direction, and
the brake fluid returning amount controlling section controls a rotation speed of the electric motor.

18. The brake control apparatus as claimed in claim 17, further comprising:
a brake operation state detecting section that detects a brake operation state of the driver;
a demand braking force calculating section that calculates a demand braking force of the driver from the detected brake operation state;
a wheel cylinder pressure calculating section that calculates a hydraulic pressure of the wheel cylinder; and
a required wheel cylinder pressure calculating section that calculates a required wheel cylinder pressure obtained on the basis of the driver's demand braking force calculated by the demand braking force calculating section, and wherein
the control unit has a motor driving section that controls a current value applied to the electric motor on the basis of the calculated wheel cylinder pressure and the calculated required wheel cylinder pressure.

19. The brake control apparatus as claimed in claim 18, wherein:
when detecting a tendency toward increase of the driver's demand braking force by the brake operation state detecting section, the control unit operates the gate-out valve in the valve opening direction, and
when detecting a tendency toward decrease of the driver's demand braking force by the brake operation state detecting section, the control unit operates the gate-out valve in the valve opening direction.

20. A method for controlling brake of a brake apparatus used for a vehicle having a regenerative braking system, the brake apparatus having:
a reservoir storing a brake fluid that flows out from a master cylinder by driver's brake operation; and
a pump capable of bidirectional rotation,
the method comprising:
pumping up the brake fluid stored in the reservoir by a rotation in a forward rotation direction of the pump and supplying the brake fluid to a wheel cylinder; and
returning the brake fluid in the wheel cylinder to the reservoir by a rotation in a reverse rotation direction of the pump in response to increase of a regenerative braking force produced by the regenerative braking system.
